(19) United States
(12) Patent Application Publication
(10) Pub. No.: US 2010/0221042 A1
(43) Pub. Date: Sep. 2, 2010

(54) ENDLESS BELT WITH MEANDERING PREVENTIVE GUIDE

(75) Inventors: Tokio Fujita, Ibaraki-shi (JP); Toshihiko Tomita, Ibaraki-shi (JP)

Correspondence Address: SUGHRUE-265550, 2100 PENNSYLVANIA AVE. NW, WASHINGTON, DC, 20037-3213, US

(73) Assignee: NITTO DENKO CORPORATION, Ibaraki-shi (JP)

(21) Appl. No.: 12/377,363

(22) PCT Filed: Sep. 21, 2006
(86) PCT No.: PCT/JP2006/318778

§ 371 Date: Feb. 12, 2009

(51) Int. Cl. G03G 15/00; G03G 15/01

(52) U.S. Cl. 399/165; 399/302

(57) ABSTRACT

The present invention provides an endless belt with a meandering preventive guide, which includes an endless belt made of resin, a pressure-sensitive adhesive layer, a meandering preventive guide member attached to the endless belt through the pressure-sensitive adhesive layer, and a primer layer provided on both surfaces of the pressure-sensitive adhesive layer.

### TECHNICAL FIELD

The present invention relates to an endless belt with a meandering preventive guide, which is useful for electrophotographic recording equipments such as printers, copying machines, and video printers.

### BACKGROUND ART

Hitherto, the endless belt has been used in intermediary transferring devices, transferring devices, carrying devices, and the like of electrophotographic recording equipments etc. For example, as shown in FIG. 1, the endless belt is used as an intermediary transferring belt 6 for an intermediary transferring device of copying machines and intermediary transfer is performed in the following process. Namely, a photosensitive drum 1 is charged by a charger 3 and exposed to light by an exposing device 2, and a toner image is formed with a toner by a developing device 5. The toner image is transferred to the intermediary transferring belt 6 by means of an electrostatic transferring device 10 and the transferred toner image is again transferred to a recording paper 11 by means of one set of pressing rollers 9, 12. The intermediary transferring belt 6 is supported by rollers 7, 8, 9 which come into contact with an inner surface of the belt.

In such an intermediary transferring belt, the endless belt is apt to meander unless it is driven with a high precision. When the belt meanders, an exposing position and a transferring position are deviated at the transfer. As a result, there sometimes arise problems that uneven images and misaligned images occur and/or the endless belt is destroyed by the meandering.

In order to prevent such meandering of the belt, a technology that a meandering preventive guide member is provided on the endless belt is known (see Patent Documents 1 and 2). Since it is difficult to attach the meandering preventive guide member to the endless belt in a seamless manner, a meandering preventive guide member having a length corresponding to the length of inner circumference of the belt is attached through a pressure-sensitive adhesive layer (see e.g., Patent Document 3).
Patent Document 1: JP-A-2000-310291
Patent Document 2: JP-A-2002-87568
Patent Document 3: JP-A-2004-53629

### DISCLOSURE OF THE INVENTION

### Problems that the Invention is to Solve

However, an advantage exhibited by the meandering preventive guide member correlates to an adhesive force between the meandering preventive guide member and the endless belt. Hitherto, in the case of the conventional meandering preventive guide member attached through a pressure-sensitive adhesive layer, the adhesive force derived from the pressure-sensitive adhesive layer alone is insufficient for the meandering preventive effect, so that peeling of the guide member and cracking of the belt sometimes occur. Accordingly, an object of the invention is to provide an endless belt having a long duration life, which is capable of preventing peeling of the meandering preventive guide member from the endless belt and being driven with a high precision.

### Means for Solving the Problems

As a result of the extensive studies for achieving the above-mentioned object, the present inventors have found that an endless belt having satisfactory properties is obtained in the case where the following requirements are combined, thereby completing the present invention.

Namely, the endless belt with a meandering preventive guide according to the invention includes an endless belt made of resin, a pressure-sensitive adhesive layer, a meandering preventive guide member attached to the endless belt through the pressure-sensitive adhesive layer, and primer layers provided on both surfaces of the pressure-sensitive adhesive layer.

The belt of the invention remarkably enhances the adhesive force between the endless belt and the meandering preventive guide member by providing primer layers on both surfaces of the pressure-sensitive adhesive layer, and hence it is possible to prevent peeling of the meandering preventive guide member from the endless belt and breakage of the endless belt itself.

Moreover, in the endless belt with a meandering preventive guide, the peeling/adhesion strength between the endless belt and the meandering preventive guide member is preferably 4 to 100 N/10 mm.

Incidentally, the peeling/adhesion strength in the invention is a value measured in accordance with JIS K 6854-1 (90° peeling test) and the measuring method is described in Examples. According to such a belt, the peeling of the meandering preventive guide member from the belt itself and the breakage of the belt can be steadily prevented.

### Advantage of the Invention

According to the endless belt of the invention, since an adhesive force between the endless belt and the meandering preventive guide member is enhanced in comparison with conventional one, the peeling of the meandering preventive guide member from an end part thereof and the breakage of the belt can be prevented, whereby an endless belt of a long duration life can be obtained.

### BRIEF DESCRIPTION OF THE DRAWINGS

FIG. 1 is a schematic constitutional view for explaining an endless belt in an intermediary transferring device of an electrophotographic copying machine in a usage state.

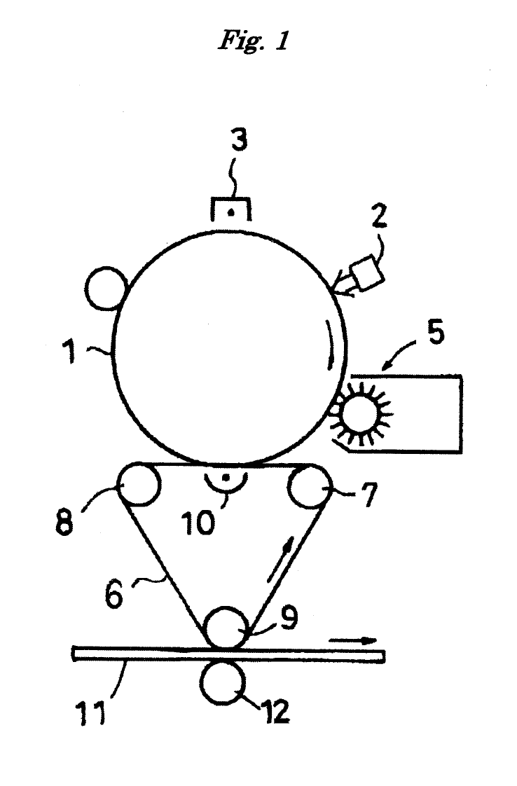

FIG. 2 is a perspective view illustrating a partial cross-section which exemplifies the endless belt with a meandering preventive guide according to the invention.

FIG. 3 is a cross-sectional view of a substantial part illustrating an attached part between a meandering preventive guide and an endless belt.

### DESCRIPTION OF REFERENCE NUMERALS AND SIGNS

1 photosensitive drum

6 intermediary transferring belt (endless belt)

7, 8 and 9 roller

11 recording paper

21 endless belt

22 meandering preventive guide (member)

23 pressure-sensitive adhesive layer

24 primer layer

### BEST MODE FOR CARRYING OUT THE INVENTION

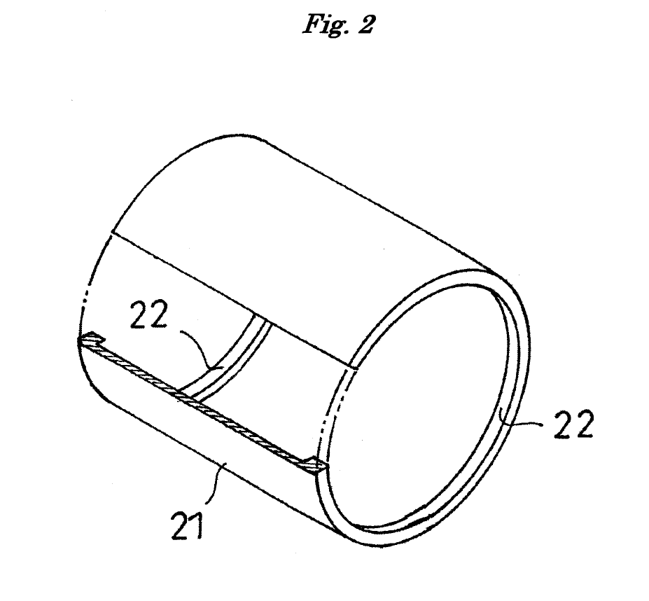

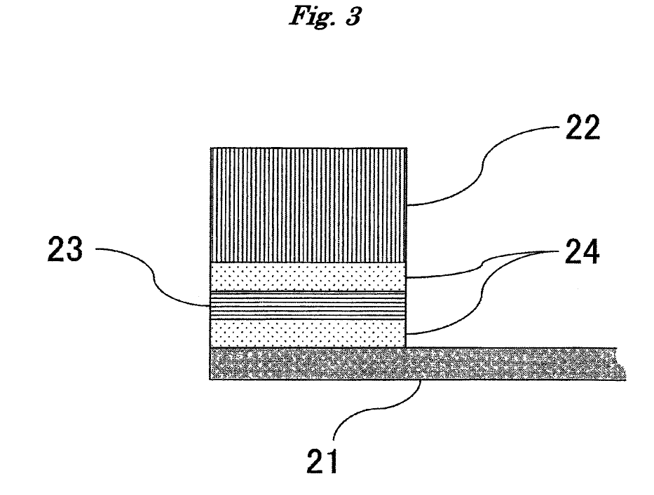

The following will explain modes for carrying out the invention with reference to Drawings. As shown in FIG. 2 and FIG. 3, the endless belt of the invention is a belt in which a meandering preventive guide 22 is attached to an endless belt 21 made of resin through a pressure-sensitive adhesive layer 23 and a primer layer 24.

The materials, shapes, sizes, functions, and the like of components excluding the primer layer, i.e., the resin endless belt, the meandering preventive guide, and the pressure-sensitive adhesive layer are not particularly limited and any conventionally known ones can be employed. For example, as the endless belt made of resin, an endless belts to be used for photosensitive devices, intermediary transferring devices, transferring separation devices, carrying devices, charging devices, developing devices, and the like in electrophotographic copying machines, laser printers, etc. may be mentioned. The materials, shapes, sizes, and the like thereof are appropriately determined depending on applications and functions thereof. As one example, in the case of the intermediary transferring belt and transfer-carrying belt in an electrophotographic recording device, a polyimide resin semi-conductive belt containing a conductive filler is used.

Including the other applications, as the material of the endless belt made of resin, a polyimide resin, a polyester resin, a polyurethane resin, a polyamide resin, a fluorocarbon resin, and the like may be mentioned. In this connection, the endless belt made of resin may or may not have a seam. Moreover, thickness of the belt itself is not particularly limited but usually it is preferable to have a thickness of about 0.05 mm to 0.5 mm.

As the meandering preventive guide member, an elastic body or the like having an appropriate hardness can be employed. Specifically, polyurethane, neoprene rubber, urethane rubber, polyester elastomer, chloroprene rubber, nitrile rubber, Butyl rubber, silicone rubber, and the like may be mentioned. Of these, urethane rubber, chloroprene rubber, and silicone rubber are preferable, and especially urethane rubber is preferable in view of adhesiveness to the pressure-sensitive adhesive layer, electrical isolation, moisture resistance, solvent resistance, ozone resistance, abrasion resistance, and the like. In addition, the hardness of the meandering preventive guide member is preferably in the range of 30° to 95°, more preferably 50° to 80° as JIS hardness.

The thickness of the meandering preventive guide member is preferably about 0.05 mm to 3.0 mm, more preferably 0.5 mm to 2 mm in view of a meandering preventive effect, durability, and the like. The width and length of the meandering preventive guide member are suitably determined depending on the shape and size of the endless belt and are not particularly limited.

As a pressure-sensitive adhesive to be used in the pressure-sensitive adhesive layer, for example, acrylic, silicone-based, natural rubber-based, synthetic rubber-based, urethane-based pressure-sensitive adhesive may be mentioned. However, since a desired adhesive strength is obtained by applying a pressure alone at ordinary temperature, an acrylic pressure-sensitive adhesive is preferable. Moreover, one or more additives may be added to the pressure-sensitive adhesive, according to the necessity.

The pressure-sensitive adhesive layer may be formed by directly applying the pressure-sensitive adhesive onto the primer layer but in view of easy handling, it is preferable to use a double-sided pressure-sensitive adhesive tape in which the pressure-sensitive adhesive is applied onto a separator beforehand, more preferably a double-sided pressure-sensitive adhesive tape having an acrylic pressure-sensitive adhesive. As the double-sided pressure-sensitive adhesive tape, a double-sided pressure-sensitive adhesive tape in which the pressure-sensitive adhesive is applied or impregnated on both surfaces of a central core substrate such as a non-woven fabric, a fabric, a plastic film, or a foam; a double-sided pressure-sensitive adhesive tape composed of the pressure-sensitive adhesive alone without using the central core substrate such as a non-woven fabric (hereinafter, sometimes referred to as a “substrate-less double-sided pressure-sensitive adhesive tape”), and the like may be mentioned. Of these, a substrate-less double-sided pressure-sensitive adhesive tape is preferably used in order to enhance the adhesive force.

Moreover, the thickness of the pressure-sensitive adhesive layer is usually preferably 5 to 500 μm, more preferably 20 to 200 μm. Namely, when the thickness of the pressure-sensitive adhesive layer is less than 5 μm, the adhesive force between the guide and the belt is insufficient. When the thickness exceeds 500 μm, the meandering preventive guide is deviated from the pressure-sensitive adhesive layer by the shearing force induced by the meandering of the guide and a high-precision belt control becomes difficult. The width and length of the pressure-sensitive adhesive layer are suitably determined depending on the shape and size of the meandering preventive guide member and are not particularly limited.

The endless belt with a meandering preventive guide according to the invention has primer layers on both surfaces of the pressure-sensitive adhesive layer. Namely, the meandering preventive guide member and the endless belt are attached to the pressure-sensitive adhesive layer through primer layers, respectively. For example, as shown in FIG. 3, a meandering preventive guide member 22 is attached to a pressure-sensitive adhesive layer 23 through a primer layer 24 and an endless belt 21 is attached to the pressure-sensitive adhesive layer 23 through another primer layer 24.

The primer to be used in the primer layer is not particularly limited so far as it can exhibit a sufficient adhesive force between the endless belt or the meandering preventive guide member and the pressure-sensitive adhesive layer. The primer is preferably a polyisocyanate primer or a polyurethane primer, more preferably a polyurethane primer. The endless belt of the invention can prevent the peeling of the meandering preventive guide member from the belt itself and the breakage of the belt itself owing to the adhesive effect between the endless belt and the meandering preventive guide member against the deformation of the belt at a roller part or the like because primer layers are provided on the endless belt side and the meandering preventive guide member side of the pressure-sensitive adhesive layer and the meandering preventive guide member is attached to the endless belt through the pressure-sensitive adhesive layer.

The thickness of the primer layer is usually preferably 0.01 to 10 μm, more preferably 0.1 to 1 μm. Namely, when the thickness of the primer layer is less than 0.01 μm, the effect of the primer is not exhibited. When the thickness exceeds 10 μm, it becomes difficult to handle the resulting product in operation. The width and length of the primer layer depend on the shapes and sizes of the meandering preventive guide member and the pressure-sensitive adhesive layer and are not particularly limited.

In the belt of the invention, larger peeling/adhesion strength between the endless belt and the meandering preventive guide member is more preferable but practically, the strength is preferably 4 to 100 N/10 mm, more preferably 6 to 50 N/10 mm.

The position to which the meandering preventive guide is attached is not particularly limited but, in view of the meandering preventive effect, durability, and a reinforcing effect, it is usually preferably provided on both edge parts of the endless belt. For example, as shown in FIG. 2 and FIG. 3, the meandering preventive guide member 22 can be attached to both edge parts of the inner circumferential surface of the endless belt 21 over the whole circumference through the primer layer 24 and the pressure-sensitive adhesive layer 23. Moreover, the meandering preventive guide member 22 may be attached after formation of the primer layer 24 and the pressure-sensitive adhesive layer 23 on the outer circumferential surface of the endless belt 21.

Furthermore, in order to prevent breakage of the belt induced by crack formation of the belt itself, a pressure-sensitive adhesive tape-like stripe-shaped member (hereinafter, sometimes referred to as a “reinforcing tape”) may be provided on the inner or outer circumferential surface of the endless belt for the purpose of enhancing strength. The primer layer may be formed on the stripe-shaped member.

The method of attaching the meandering preventive guide member to the endless belt is not particularly limited but, for example, the following method can be mentioned as a suitable method.

First, a primer layer 24 is formed on the meandering preventive guide member 22 by applying a primer to the meandering preventive guide member 22, followed by drying and the like. Then, the pressure-sensitive adhesive layer 23 is formed on the primer layer 24. As a method of forming the pressure-sensitive adhesive layer 23, a method of directly applying a pressure-sensitive adhesive on the primer layer 24, a method of adhesion using a double-sided pressure-sensitive adhesive tape, or the like method may be mentioned. However, in view of easy handling, the method of using a double-sided pressure-sensitive adhesive tape is preferable. Then, a primer is applied on the endless belt 21 to form another primer layer 24, and the endless belt with a meandering preventive guide according to the invention can be obtained by attaching the pressure-sensitive adhesive layer 23 formed on the meandering preventive guide member 22 to the primer layer 24 formed on the endless belt 21.

In this connection, it is important to attached individual layers one another without entry of air bubbles and usually, a method of attaching by means of a hand roller, a rubber roller, a press, or the like, a method of attaching under reduced pressure or under pressurization, or the like method can be employed.

### Examples

The following will further describe the invention with reference to specific Examples, but the invention is not limited to these Examples.

Incidentally, materials used in Examples and Comparative Examples are as follows.

### 1. Meandering Preventive Guide Member

(1) a urethane rubber (Typrene TR100-50 manufactured by Tigers Polymer Corporation)

### 2. Endless Belt

(1) a polyimide endless belt

### 3. Reinforcing Tape

(1) a polyester pressure-sensitive adhesive tape (NO. 31B tape manufactured by Nitto Denko Corporation)

### 4. Pressure-Sensitive Adhesive

(1) an acrylic pressure-sensitive adhesive (LA-150 double-sided tape (substrate-less double-sided pressure-sensitive adhesive tape) manufactured by Nitto Denko Corporation)
(2) an acrylic pressure-sensitive adhesive (NO. 500 double-sided tape (double-sided pressure-sensitive adhesive tape having a substrate of non-woven cloth) manufactured by Nitto Denko Corporation)

### 5. Primer

(1) a polyurethane-based primer (seal primer #7 manufactured by Konishi Co., Ltd.)
(2) an isocyanate-based primer (N-200 manufactured by 3M)
(3) an isocyanate-based primer (Desmodur RE manufactured by Bayer)

Methods for evaluation in Examples and Comparative Examples are as follows.

### 1. Durability Test

An endless belt of a width of 300 mm and an outer diameter of 300 mm having a meandering preventive guide member attached on both edge parts was continuously driven for 100 hours under conditions of a roll diameter of 30 mm, a roll speed of 100 mm/minute, and a belt tension of 5 kg/300 mm, and peeling of the meandering preventive guide member and breakage of the belt were evaluated. A belt showing no change was ranked as “A” and a belt in which peeling of the meandering preventive guide member and/or breakage of the belt occur was ranked as “B”.

### 2. Peeling/Adhesion Strength Test

A substrate for an endless belt cut into a stripe having a width of 10 mm was attached to a urethane rubber to be used as a meandering preventive guide member through a pressure-sensitive adhesive layer or a pressure-sensitive adhesive layer and a primer layer under a condition of a rubber roller of 2 kg load. Adhesion strength was measured by 90° peeling measurement at a peeling rate of 300 mm/minute on a tensile testing machine in accordance with a test method for peeling/adhesion strength, JIS K 6854-1 (90° peeling test). As the tensile testing machine, Autograph AG500E manufactured by Shimadzu Corporation was employed.

### Example 1

Seal primer #7 manufactured by Konishi Co., Ltd. was applied on a urethane rubber (Typrene TR100-50 manufactured by Tigers Polymer Corporation) having a thickness of 1.0 mm to be used as a meandering preventive guide member. After drying, a double-sided tape LA-150 was attached thereto and was cut into a stripe having a width of 5 mm and a length of 942 mm by means of a slitter to obtain a meandering preventive guide member having a primer layer and a pressure-sensitive adhesive layer. Then, a polyester tape having a width of 10 mm as a reinforcing tape was attached to an inner surface of a polyimide belt having a thickness of 80 μm, an outer diameter of 300 mm, and a width of 300 mm. Further, Seal primer #7 manufactured by Konishi Co., Ltd. was applied on the polyester tape and the meandering preventive guide member was attached to each of both edge parts of the belt along the edge parts. As a result of evaluation by the durability test using the resulting belt, neither peeling of the guide member nor breakage of the belt occurred. The peeling/adhesion strength between the endless belt substrate and the meandering preventive guide member on this occasion was found to be 10.5 N/10 mm.

### Example 2

A belt was prepared in the same manner as in Example 1 except that N-200 primer manufactured by 3M was applied on the polyester tape attached as a reinforcing tape to the inner surface of the polyimide belt. As a result of evaluation by the durability test using the resulting belt, neither peeling of the guide member nor breakage of the belt occurred. The peeling/adhesion strength between the endless belt substrate and the meandering preventive guide member on this occasion was found to be 9.1 N/10 mm.

### Example 3

A belt was prepared in the same manner as in Example 1 except that the double-sided tape used was changed into NO. 500 double-sided tape manufactured by Nitto Denko Corporation. As a result of evaluation by the durability test using the resulting belt, neither peeling of the guide member nor breakage of the belt occurred. The peeling/adhesion strength between the endless belt substrate and the meandering preventive guide member on this occasion was found to be 4.9 N/10 mm.

### Comparative Example 1

No primer was applied on a urethane rubber (Typrene TR100-50 manufactured by Tigers Polymer Corporation) having a thickness of 1.0 mm to be used as a meandering preventive guide member. A substrate-less double-sided tape LA-150 was directly attached thereto and was cut into a stripe having a width of 5 mm and a length of 942 mm by means of a slitter to obtain a meandering preventive guide member. Then, a polyester tape having a width of 10 mm as a reinforcing tape was attached to an inner surface of a polyimide belt having a thickness of 80 μm, an outer diameter of 300 mm, and a width of 300 mm. Further, no primer was applied and the meandering preventive guide member obtained as above was attached to each of both edge parts of the belt along the edge parts. As a result of evaluation by the durability test using the resulting belt, peeling of the meandering preventive guide member occurred after 12 hours. The peeling/adhesion strength between the endless belt substrate and the meandering preventive guide member on this occasion was found to be 2.5 N/10 mm.

### Comparative Example 2

A belt was prepared in the same manner as in Comparative Example 1 except that N-200 primer manufactured by 3M as a primer for rubber was applied on a urethane rubber (Typrene TR100-50 manufactured by Tigers Polymer Corporation) having a thickness of 1.0 mm. As a result of evaluation by the durability test using the resulting belt, peeling of the meandering preventive guide member occurred after 35 hours. The peeling/adhesion strength between the endless belt substrate and the meandering preventive guide member on this occasion was found to be 3.8 N/10 mm.

### Comparative Example 3

A belt was prepared in the same manner as in Comparative Example 1 except that Desmodur RE primer manufactured by Bayer was applied on the polyester tape attached as a reinforcing tape to the inner surface of the polyimide belt. As a result of evaluation by the durability test using the resulting belt, peeling of the meandering preventive guide member occurred after 20 hours. The peeling/adhesion strength between the endless belt substrate and the meandering preventive guide member on this occasion was found to be 3.5 N/10 mm.

### Comparative Example 4

A belt was prepared in the same manner as in Comparative Example 1 except that Desmodur RE primer manufactured by Bayer as a primer for rubber was applied on a urethane rubber (Typrene TR100-50 manufactured by Tigers Polymer Corporation) having a thickness of 1.0 mm. As a result of evaluation by the durability test using the resulting belt, peeling of the meandering preventive guide member occurred after 26 hours. The peeling/adhesion strength between the endless belt substrate and the meandering preventive guide member on this occasion was found to be 3.7 N/10 mm.

TABLE 1

| | Peeling/adhesion strength | |
|---|---|---|
| | (N/10 mm) | Durability test |
| Example 1 | 10.5 | A |
| Example 2 | 9.1 | A |
| Example 3 | 4.9 | A |
| Comparative | 2.5 | B |
| Example 1 | | |
| Comparative | 3.8 | B |
| Example 2 | | |
| Comparative | 3.5 | B |
| Example 3 | | |
| Comparative | 3.7 | B |
| Example 4 | | |

### Adhesion Strength

### (N/10 mm) Durability Test Example 110.5A Example 29.1A Example 34.9A Comparative Example 12.5B Comparative Example 23.8B Comparative Example 33.5B Comparative Example 43.7B

As shown by the results in Table 1, in the cases of the belts of Examples 1 to 3 having primer layers on both of the endless belt side and the meandering preventive guide side (both surfaces of the pressure-sensitive adhesive layer), neither peeling of the guide member nor breakage of the belt occurred even after 100 hours of the continuous durability test. On the other hand, in the cases of the belts of Comparative Examples 1 to 4 in which a primer layer was not provided on both or one of the endless belt side and the meandering preventive guide side, peeling of the meandering preventive guide member occurred after 12 hours, 35 hours, 20 hours, and 26 hours, respectively.

While the invention has been described in detail and with reference to specific embodiments thereof, it will be apparent to one skilled in the art that various changes and modifications can be made therein without departing from the spirit and scope thereof.

The present application is based on Japanese Patent Application No. 2005-088051 filed on Mar. 25, 2005, and the contents are incorporated herein by reference.

### INDUSTRIAL APPLICABILITY

The endless belt with a meandering preventive guide according to the invention can be suitably used for electrophotographic recording devices such as printers, copying machines, and video printers.

1. An endless belt with a meandering preventive guide, said endless belt comprising:
an endless belt comprising a resin,
a pressure-sensitive adhesive layer,
a meandering preventive guide member attached to the endless belt through the pressure-sensitive adhesive layer, and
a primer layer provided on both surfaces of the pressure-sensitive adhesive layer.

2. The endless belt with a meandering preventive guide according to claim 1, wherein a peeling/adhesion strength between the endless belt and the meandering preventive guide member is 4 to 100 N/10 mm.
